(19) United States
(12) Patent Application Publication
(10) Pub. No.: US 2008/0099715 A1
(43) Pub. Date: May 1, 2008

(54) Polymer Beads Incorporating Iron Oxide Particles

(75) Inventors: Beryn John Adams, Victoria (AU); Robert James Eldridge, Victoria (AU); Warren Shane Knower, Victoria (AU); Fiona Jean Wallis, Victoria (AU); Colin Bruce Ritchie, Victoria (AU); Matthew Roy Raymond, Victoria (AU)

Correspondence Address: GREENLEE WINNER AND SULLIVAN P C, 4875 PEARL EAST CIRCLE, SUITE 200, BOULDER, CO, 80301, US

(73) Assignees: COMMONWEALTH SCIENTIFIC AND INDUSTRIAL RESEARCH OR, Campbell (AU); ORICA AUSTRALIA PTY LTD, Melbourne (AU)

(21) Appl. No.: 10/599,210

(22) PCT Filed: Mar. 23, 2005
(86) PCT No.: PCT/AU05/00419

§ 371 Date: May 31, 2007

(30) Foreign Application Priority Data
Mar. 23, 2004 (AU) 2004901545

(51) Int. Cl. B01J 39/12; H01F 1/06

(52) U.S. Cl. 252/62.54; 521/28

(57) ABSTRACT

The invention provides a process for preparing polymer beads incorporating magnetic iron oxide particles, which process comprises producing a dispersion having a continuous aqueous phase and a dispersed organic phase, the organic phase comprising one or more polymerisable monomers, magnetic iron oxide particles and an organophosphorus dispersing agent for dispersing the magnetic iron oxide particles in the organic phase, and polymerising the one or more polymerisable monomers to form the polymer beads incorporating the magnetic iron oxide particles; complexing and ion exchange resins prepared by this process; methods for separating transition metal ions and other ions from an aqueous solution using the complexing and ion exchange resins; and polymer beads comprising a polymeric matrix having magnetic iron oxide particles and organophosphorus dispersing agent dispersed substantially uniformly therein.

### FIELD OF THE INVENTION

The present invention relates to polymer beads incorporating magnetic iron oxide particles and processes for their preparation. The polymer beads are particularly suitable for use as ion exchange or complexing resins and accordingly it will be convenient to hereinafter describe the invention with reference to these applications. However, it is to be understood that the polymer beads can be used in other applications, for example in magnetic cell sorting, as absorbent materials for neutral molecules, or as chromatographic separation media in magnetically stabilised beds.

### BACKGROUND OF THE INVENTION

Ion exchange/complexation is widely used as a technique for removing both organic and inorganic species from water. These techniques conventionally involve passing water through a packed bed or column of ion exchange/complexing resin. Target species are removed by being adsorbed or complexed onto the resin. Such resins are commonly used for removing contaminants from water. However, the effective use of many commercial resins in high volume treatment applications is often not viable. In particular, many commercial resins function ineffectively at short contact times. Treating substantial flows of water or liquid at adequate contact times therefore requires the use of very large columns which often renders the process uneconomic.

Resins incorporating magnetic particles have been described as being particularly suitable for applications involving continuous high flows. In the absence of shear, attraction between the magnetic particles in the resin causes the resin beads to flocculate and settle rapidly, enabling such resins to be readily separated under demanding process conditions. Accordingly, these resins can be advantageously used without the need for packed beds or large columns. For the magnetic resins to operate effectively, the magnetic particles should be incorporated into the resin in a manner that prevents their loss by erosion or dissolution during use. For this reason it is highly desirable that the magnetic particles should be dispersed evenly throughout the polymer bead. Improved mechanical strength is a further benefit of even particulate dispersion.

In addition, for ease of handling in use the resins should be substantially spheroidal or ellipsoidal in form, substantially uniform in size and free of very small particles. Such properties minimise attrition and also enhance the flow properties of a dry resin or a concentrated suspension of the resin in water so that it can be readily metered or pumped.

Processes for the manufacture of polymer beads incorporating magnetic iron oxide particles have been described in some prior art patents. For example, U.S. Pat. No. 2,642,514 discloses an ion exchange process using a mixed ion exchange resin. One of the ion exchange resins is a magnetic resin. The magnetic resin is produced by polymerising a reagent mix until a viscous syrup is obtained. Magnetite is added to the viscous syrup and the mixture is agitated to mix in the magnetite. The mixture is cured to form a hard resin that is subsequently ground to form irregular particles of magnetic resin.

European Patent Application No. 0,522,856 also discloses the manufacture of magnetic ion exchange resins by grinding or crushing a polymer having magnetite dispersed throughout the polymer matrix. The processes for producing magnetic ion exchange resins disclosed in U.S. Pat. No. 2,642,514 and EP 0,522,856 require a grinding step, which increases the cost and complexity of the process and increases losses due to the formation of polymer particles outside the desired particle size range during the grinding step. Further, the ground particles are irregular in shape and easily abraded.

Many of the aforementioned difficulties associated with producing polymer beads incorporating magnetic particles can be overcome by using the process disclosed in Australian patent No.704376. This patent describes an aqueous suspension polymerisation process which involves polymerising a dispersed organic phase comprising monomer, magnetic powder and a dispersing agent. During polymerisation the dispersing agent reacts with monomer to become covalently bound within the resin. By this process, spherical polymeric beads having an even distribution of magnetic powder throughout can be produced.

However, incorporation of magnetic particles, such as magnetic iron oxide particles, into 5 polymer beads by the process disclosed in Australian Patent No. 704376 can be inefficient. In particular, by this process a significant proportion, for example about 5%, of magnetic iron oxide particles will typically be excluded from the polymer beads during polymerisation. As a result, the yield of the process is reduced and the complexity of post-polymerisation washing is increased.

Accordingly, there remains an opportunity to develop a more efficient process for preparing polymer beads incorporating magnetic iron oxide particles.

### SUMMARY OF THE INVENTION

In one aspect, the present invention provides a process for preparing polymer beads incorporating magnetic iron oxide particles, which process comprises producing a dispersion having a continuous aqueous phase and a dispersed organic phase, the organic phase comprising one or more polymerisable monomers, magnetic iron oxide particles and an organophosphorus dispersing agent for dispersing the magnetic iron oxide particles in the organic phase, and polymerising the one or more polymerisable monomers to form the polymer beads incorporating the magnetic iron oxide particles.

In a further aspect, the present invention provides polymer beads comprising a polymeric matrix having magnetic iron oxide particles and an organophosphorus dispersing agent dispersed substantially uniformly therein.

The polymeric beads according to the invention are preferably macroporous, being prepared by incorporating one or more porogens in the dispersed organic phase.

Surprisingly, it has now been found that organophosphorus dispersing agents not only function to effectively disperse magnetic iron oxide particles in the dispersed organic phase according to the process of the invention, but they also enhance incorporation of the particles in the polymer beads during polymerisation. Accordingly, by this process substantially all magnetic iron oxide particles can be incorporated into the polymer beads during polymerisation over the range of particle loadings typically employed. Polymer beads can therefore be prepared by this process in superior yield, and the resulting beads are more readily cleaned.

Furthermore, macroporous polymer beads prepared in accordance with the invention show an enhanced density by virtue of their uniformly distributed porosity. When used as an ion exchange/complexing resin, such polymer beads therefore advantageously exhibit a higher settling rate and functional capacity.

### Description of the Preferred Embodiments

As used herein, the term “magnetic” is intended to denote a property of a substance which enables it to be magnetised. Accordingly, reference to a “magnetic iron oxide particle” or a “magnetic ion exchange/complexing resin” implies that these substances are at least capable of being magnetised, if not already in a magnetised state.

In accordance with the process of the present invention the organic phase is the dispersed phase. The organic phase includes one or more polymerisable monomers that polymerise to form the polymeric matrix of the polymeric beads. It is preferred that the polymeric matrix is a copolymer based on two (or more) monomers. Generally the polymer beads will be prepared from polymerisable monomers selected from:
(a) crosslinking monomers which are able to provide crosslink points; and
(b) functional monomers which are able to provide functional groups.

The organic phase used in accordance with the invention preferably includes crosslinking monomers and functional monomers. The selection of specific monomers will generally be dictated by the intended application in which the beads are to be employed. A combination of two or more different crosslinking monomers and/or different functional monomers may also be used.

When the polymer beads are to be used as an ion-exchange or complexing resin, the organic phase will include polymerisable monomers which provide the necessary functional groups which (a) directly give the polymer beads an ion-exchange or complexing capability, or (b) may be reacted to provide functional groups which confer ion-exchange or complexing capability to the polymer beads.

When the polymer beads are to be used as a complexing resin, it is preferable that the beads include amine groups capable of complexing a transition metal cation, or the beads are reacted with one or more compounds to provide amine groups capable of complexing a transition metal cation. Accordingly, the polymer beads may be prepared using amine functionalised polymerisable monomers that provide the necessary amine groups. Alternatively, the polymer beads may be prepared using functional monomers that provide functional groups which can be converted by, or reacted with, one or more compounds to provide the necessary amine groups.

Polymeric beads of the present invention comprising complexing amine groups advantageously demonstrate an ability to selectively remove transition metals from aqueous solutions in the presence of innocuous background ions under continuous high flow conditions.

When the polymer beads are to be used as an ion exchange resin, it is preferable that the beads include amine groups, quaternary ammonium groups, or acidic groups such as carboxylic or sulphonic acid groups, or the beads are reacted with one or more compounds to provide such groups. Accordingly, the polymer beads may be prepared using amine or acidic functionalised polymerisable monomers that provide the necessary amine, quaternary amine or acidic groups. Alternatively, the polymer beads may be prepared using functional monomers that provide functional groups which can be converted by, or reacted with, one or more compounds to provide the necessary amine, ammonium or acidic groups.

Those skilled in the art will appreciate that a wide range of functional monomers may be used in the process of the present invention.

Where the polymer beads are to be used as an ion-exchange resin, suitable monomers include styrene, methylstyrene, methacrylic or ethacrylic acid, glycidyl methacrylate, vinyl benzyl chloride, dimethylaminoethyl methacrylate, N,N-dimethylaminopropyl acrylamide and methacrylamide, vinyl pyridine, organic-soluble diallylamine or vinylimidazole salts, and their quaternized derivatives, N-vinyl formamide, and methyl and ethyl acrylate . This list is not exhaustive.

Where the polymer beads are to be used as a complexing resin, suitable monomers include glycidyl methacrylate, vinyl benzyl chloride, methyl and ethyl acrylate, N-vinyl formamide, dimethylaminoethyl methacrylate, aminopropyl acrylamide and methacrylamide, N,N-dimethylaminopropyl acrylamide and methacrylamide, vinyl pyridine and organic-soluble diallylamine or vinylimidazole salts. This list is not exhaustive.

When used, the cross-linking monomer may be selected from a wide range of monomers which include, but are not limited to, divinyl monomers such as divinyl benzene, ethyleneglycol dimethacrylate or poly(ethyleneglycol) dimethacrylate, ethyleneglycol divinylether and polyvinyl ester compounds having two or more double bonds.

Some monomers, such as bis(diallylamino)alkanes or bis(acrylamidoethyl)amine can function as both crosslinking monomers and functional monomers.

The polymer matrix of the beads may be a copolymer matrix. Accordingly, other monomers may be included in the organic phase to copolymerise with the crosslinking monomers and the functional monomers, for example backbone monomers may be included.

The backbone monomers include any monomer that can be polymerised by free radical polymerisation and include, but are not limited to, styrene, methylstyrene (ie o-, m-, or p-methylstyene), methyl methacrylate and other acrylates, methacrylates and combinations thereof.

The process of the present invention utilises an organophosphorus dispersing agent for dispersing the iron oxide magnetic particles in the dispersed phase. The dispersing agent acts to disperse the magnetic particles in the droplets of the dispersed phase to form a stable dispersion (or suspension) of the magnetic particles in the dispersed phase, which in turn promotes a substantially even distribution of magnetic particles throughout the resultant polymer beads. The problem of erosion of the magnetic particles from the polymer beads in service, as may happen if the magnetic particles were located only on the outer surface of the beads, is therefore avoided, or at least alleviated.

The use of an organophosphorus dispersing agent in accordance with the process of the invention also enhances incorporation of the magnetic iron oxide particles during polymerisation. Without wishing to be limited by theory, it is believed that a phosphorus group contained within the dispersing agent binds to the surface of the magnetic iron oxide particles, and this binding effect, coupled with retention of the dispersing agent within the dispersed organic phase during polymerisation, provides for the enhanced incorporation of the magnetic particles in the resultant polymer beads.

The ability of a specific organophosphorus dispersing agent to enhance incorporation of magnetic iron oxide particles during polymerisation is therefore believed to be influenced by the dispersing agent's binding capacity with the magnetic iron oxide particles, and polarity characteristics of the dispersing agent, the particles, the dispersed organic phase and the continuous aqueous phase.

The organophosphorus dispersing agent preferably comprises one or more phosphate, phosphonic, or phosphonate group that binds to the surface of the magnetic iron oxide particles. The organophosphorus dispersing agent may also contain a combination of such groups.

The organophosphorus dispersing agent is preferably ionised or capable of being ionised. For avoidance of any doubt, by the organophosphorus dispersing agent being “ionised” is meant that the phosphorus moiety, for example a phosphate, phosphonic, or phosphonate group, of the agent is ionised (ie in the form of a salt). By the organophosphorus dispersing agent being “capable of being ionised” or being “ionisable” is meant that the phosphorus moiety, for example a phosphate, phosphonic, or phosphonate group, of the agent is cable of ionising in an aqueous solution. Those skilled in the art will appreciate that an “ionised” phosphorus moiety will typically comprise a counter cation, for example a metal cation or organic cation, and that an “ionisable” phosphorus moiety will typically comprise one or more acidic protons.

Those skilled in the art will also appreciate the various ways in which the organophosphorus dispersing agents may be provided in the form of a salt. For example, the acidic proton(s) of a phosphonic acid or ionisable phosphate ester can be neutralised with a metal oxide, hydroxide or carbonate, such as sodium hydroxide, potassium hydroxide, magnesium oxide or sodium hydrogen carbonate, or with an organic base, such as isopropylamine, cyclohexylamine, diethylamine, triethylamine or tetramethylammonium hydroxide. The ionised phosphorus moiety will then of course bear an anionic charge that is balanced by the charge of the counter cation derived from the neutralising reagent.

The ability of an organophosphorus dispersing agent to be retained within the dispersed organic phase in preference to the continuous aqueous phase during polymerisation will typically depend on both the nature of the dispersed organic phase and the nature of the organo-component of the dispersing agent. Those skilled in the art will readily appreciate the characteristics of various organo-components that would enable a given dispersing agent to be preferentially retained within a particular dispersed organic phase.

Preferred organo-components or substituents of the organophosphorus dispersing agents include, but are not limited to, C₄ to C₄₀, preferably C₈ to C₁₈, linear or branched alkyl groups, fatty acid or alcohol residues and their ethoxylated derivatives, aromatic or phenolic groups and their ethoxylated derivatives, alkylated aromatic or phenolic groups and their ethoxylated derivatives and organic soluble polyester or polyamide chains. Particularly preferred organo-substituents of the dispersing agents are independently selected from C₈ to C₁₈ linear or branched alkyl groups and their ethoxylated derivatives.

Preferred organophosphorus dispersing agents comprise a phosphorus group selected from an ionizable phosphate ester group, a phosphonic acid group and salts thereof. Those skilled in the art will appreciate that a salt of a phosphonic acid group is commonly referred to as a phosphonate group.

Particularly preferred organophosphorus dispersing agents comprise a phosphorus group selected from an ionizable phosphate ester group, a phosphonic acid group and salts thereof, and either one or two organo-substituents independently selected from C₈ to C₁₈ linear or branched alkyl groups and their ethoxylated derivatives. An organophosphorus dispersing agent having an ionisable phosphate ester group or a phosphonic acid group and one such organo-substituent will typically therefore each have two ionisable protons, and an organophosphorus dispersing agent having an ionisable phosphate ester group or a phosphonate ester group and two such organo-substituents will typically therefore each have one ionisable proton.

Those skilled in the art will appreciate that numerous organophosphorus dispersing agents are sold commercially. Such dispersing agents are typically provided in the form of a formulation and the dispersing agent itself only represents a portion of the overall formulation. These commercial formulations can advantageously be used in accordance with the present invention provided that the other constituents in the formulation do not adversely affect the process of preparing the polymer beads, or the properties of the resultant polymer beads.

Preferred commercial organophosphorus dispersing agents include, but are not limited to Solsperse® 61,000 sold by Avecia, Teric®305 and Alkanate®40PF sold by Huntsman, Crafol® AP12, AP60 and AP69 sold by Cognis, Disponil® AEP8100 and AEP5300 sold by Henkel, and Rhodafac® PE501 sold by Rhodia.

In order to increase the efficiency of removal of contaminants from water being treated by the polymer beads as an ion exchange or complexing resin, it is preferred that the polymer beads are macroporous. This increases the total surface area of each bead available for contact. To produce macroporous polymer beads according to the present invention, the dispersed phase should include one or more porogens. The porogen becomes dispersed throughout the droplets that form the dispersed phase, but the porogen does not take part in the polymerisation reaction. Accordingly, after the polymerisation reaction is completed, the porogen can be removed from the polymer beads, for example by washing or steam stripping, to produce macroporosity in the polymer beads.

Surprisingly, it has been found that when an organophosphorus dispersing agent is included in the process of the invention together with one or more porogens, the resultant macroporous polymer beads have a higher density compared with macroporous polymer beads prepared in the absence of an organosphosphorus dispersing agent. The increased density of these macroporous polymer beads can be attributed to their fine and substantially uniform porous structure. Increased density advantageously provides the polymer beads with a higher functional capacity as an ion exchange/complexing resin. Since more functional groups are contained within a given volume of settled resin or a vessel of given size, the cost-effectiveness of the resin is enhanced.

Suitable porogens for use in the process of the present invention include aromatic compounds such as toluene and benzene, alcohols such as butanol, iso-octanol, cyclohexanol, dodecanol, isoamyl alcohol, tertiary amyl alcohol and methyl iso-butyl carbinol, esters such as ethyl acetate and butyl acetate, saturated hydrocarbons such as n-heptane, iso-octane, halogenated solvents such as dichloroethane and trichloroethylene, plasticisers such as dioctylphthalate and dibutyl adipate, polymers such as polystyrene and polyvinyl acetate; and mixtures thereof. Mixtures of cyclohexanol with other porogens such as dodecanol or toluene have been found to be especially suitable for use as a porogen in the process of the present invention. It will be appreciated that the above list of porogens is not exhaustive and that the invention encompasses the use of other porogens and other combinations of porogens.

Incorporation of iron oxide magnetic particles into the polymer beads results in the beads becoming magnetic. Magnetic separation techniques may be used to conveniently separate the beads from a solution or liquid being treated. Alternatively, the beads can be separated by settling under gravity, which is advantageously accelerated by magnetic aggregation. Examples of suitable magnetic iron oxide particles include, but are not limited to, include γ-iron oxide (γ-Fe₂O₃, also known as maghemite) and magnetite (Fe₃O₄). Ferrites which are mixed oxides with Zn, Ba, Mn etc can also be used. Whether a magnetically hard or soft ferrite is preferred will depend on the magnetic separation technique to be employed. Iron oxides may be made in ferrimagnetic or superparamagnetic forms by controlling their particle size. Maghemite is especially preferred because it is inexpensive.

The magnetic material is added during the process in the form of particles and it may or may not be magnetised upon addition. The particle size of the particles may range up to a size that is up to one-tenth of the particle size of the polymer beads formed in the process of the present invention. Particles that are larger than that may be difficult to evenly disperse into the polymer beads. More preferably, the particles of magnetic material range in size from sub-micron (e.g.0.1 μm) to 50 μm, most preferably from 0.1 μm to 10 μm.

The process of the present invention is preferably performed by a suspension polymerisation reaction, and techniques known to those skilled in the art to control and monitor such reactions apply to the present invention. In order to maintain the dispersed phase in the form of suspended droplets in the continuous phase whilst avoiding aggregation of the droplets, a stabilising agent is preferably used. Suitable stabilising agents may include, but are not limited to, polyvinyl alcohol, gelatine, methyl cellulose or sodium polyacrylate. It is to be understood that the invention extends to cover any stabilising agent that may be suitable for use. The stabilising agent is typically present in an amount of 0.01 to 5.0% by weight, and preferably 0.05 to 2.0% by weight, based on the weight of the whole mixture.

It will also be generally necessary to use an initiator to initiate the polymerisation reaction. The initiator to be used depends upon the monomers present in the reaction mixture, and the choice of initiator and the amount required will be readily apparent to the skilled addressee. By way of example only, suitable initiators include azoisobutyronitrile, benzoyl peroxide, lauroyl peroxide and t-butyl hydroperoxide. The amount of initiator used is generally in the range of 0.01 to 5.0 wt %, more preferably 0.10 to 1.0%, calculated on the total weight of monomer(s).

In a preferred embodiment of the present invention, the monomer mixture may include a functional monomer present in an amount of from 10 to 99% by weight, based upon the weight of total monomers, more preferably 50 to 90% by weight (same basis). The crosslinking monomers may be present in an amount of from 1 to 90% by weight, based on the weight of total monomers, more preferably 10 to 50% by weight (same basis). Additional monomers may be present in an amount of 0 to 60% by weight, more preferably 0 to 30% by weight, based on the weight of total monomers. The total monomers may constitute from 1 to 50%, more preferably 5 to 30% by weight of the whole suspension polymerisation mixture.

The magnetic iron oxide particles are preferably added in an amount of from 10 to 300 wt %, based on the weight of total monomers, more preferably 20 to 100% by weight (same basis). The organophosphorus dispersing agent is preferably added in an amount of 0.10 to 30% by weight, more preferably 1 to 10% by weight, based on the weight of magnetic particles.

The dispersion of the dispersed phase (which includes the monomer(s)) in the continuous phase is usually achieved by mixing the organic and aqueous phases and shearing the resulting mixture. The shear applied to the dispersion can be adjusted to control the size of the droplets of the dispersed phase. As the droplets of dispersed phase are polymerised to produce the polymer beads, the shear applied to the dispersion largely controls the particle size of the polymer beads. Generally, the polymer beads are controlled to have a particle size within the range of 10 to 5000 μm, preferably within the range 30 to 1000 μm.

Once a stable dispersion of dispersed phase in continuous phase is established, the polymerisation reaction is initiated by heating the dispersion to the desired reaction temperature. The dispersion may be held at the desired reaction temperature until the polymerisation reaction is substantially complete.

In conducting the polymerisation reaction, the monomers will be selected to provide polymer beads that are suited to a particular application. For example, depending upon the monomers used, the resulting polymer beads may include acid or amine groups that will enable the polymeric beads to act as an ion exchange or complexing resin, the functional groups being directly provided by the polymerised residues of one or more of the functional monomers.

Functional monomers capable of directly introducing amine functionality to the beads include, but are not limited to, dimethylaminoethyl methacrylate, aminopropyl acrylamide and methacrylamide, N,N-dimethylaminopropyl acrylamide and methacrylamide, vinyl pyridine, and organic-soluble diallylamine or vinylimidazole salts.

Functional monomers capable of directly introducing acid functionality to the beads include, but are not limited to, methacrylic and ethacrylic acids.

Alternatively, once the polymerisation is complete, the resulting polymer beads may require subsequent treatment to provide the functional groups that will enable the polymer beads to act as an ion exchange or complexing resin. The particular treatment process used will be dependent on the composition of the polymer beads to be treated. The treatment process may involve reacting the polymer beads with one or more compounds that convert functional groups present on the beads into ion exchange or complexing groups, or reacting functional groups on the beads with one or more compounds that introduce ion exchange or complexing groups to the beads.

In a treatment process where functional groups on the beads are converted into ion exchange or complexing groups, the functional groups are preferably converted into amine or acid groups, or salts thereof, or quaternary ammonium groups. Various combinations of suitable functional groups and reactants may be employed for this purpose, the nature of which would be known to those skilled in the art. In this case, it is preferable that the functional groups on the beads are amide or ester groups, and more preferable that the amide or ester groups are introduced to the polymer beads by way of an amide or ester functional monomer.

Exemplary amide functional monomers include, but are not limited to, N-vinyl formamide or N-methyl-N-vinyl acetamide. Amide groups can be readily converted to amine groups by hydrolysis, Hofmann degradation or borohydride reduction. Hydrolysis is a preferred technique. For example, amide groups in N-vinylformamide or N-methyl-N-vinylacetamide monomer units can be converted to amine groups by hydrolysis. Amine groups can be readily converted into a salt or quaternary ammonium group.

Exemplary ester functional monomers include, but are not limited to, methyl-, ethyl-, or butyl acrylate. Ester groups can be readily converted to weak acid groups by hydrolysis. For example, ester groups in methyl-, ethyl-, or butyl acrylate monomer units can be converted to weak acid groups by hydrolysis.

In a treatment process where functional groups on the beads are reacted with one or more compounds which contain functional groups that introduce ion exchange or complexing groups to the beads, the one or more compounds preferably introduce amine or quaternary ammonium groups. Various combinations of suitable functional groups and reacting compounds may be employed for this purpose, the nature of which would be known to those skilled in the art. In this case, it is preferred that the functional groups on the beads include, but are not limited to, halogens, epoxides, esters and amides. It is preferable that such functional groups are introduced to the polymer beads by way of appropriate functional monomers. Exemplary functional monomers for this purpose include, but are not limited to, vinyl benzyl chloride, glycidyl methacrylate, acrylate or methacrylate esters or amides (as defined above). Such functional groups can be reacted with compounds that introduce amine or quaternary ammonium groups. Suitable reactant compounds include, but are not limited to, amines, diamines, and polyamine compounds and their respective salts. Preferred compounds for introducing amine or quaternary ammonium groups include, but are not limited to, piperidine, N, N-diethylethylene diamine, dimethylamine, diethylamine, trimethylamine, triethylamine, 3-dimethylaminopropylamine, ethylenediamine, diethylenetriamine, polyethyleneimine and their respective salts.

The complexing properties of polymer beads comprising amine groups will be primarily dictated by the nature of the amine groups present therein. Such amine groups should be readily accessible to undergo complexation with transition metal cations. It will be appreciated by those skilled in the art that amine groups to be included in the polymeric beads, either by direct polymerisation or by subsequent treatment, generally have little or no affinity to complex with alkali and alkaline earth metal cations, but can readily complex with transition metal cations. Those skilled in the art will also appreciate that the selection of amine groups to be included in the polymer beads will be dependent on both the nature of the species to be separated and the nature of background ions present in the solution. Selectivity may be affected by factors such as steric crowding of the nitrogen atoms, electron density on the nitrogen atoms and the availability of multiple nitrogen atoms to form chelate complexes.

Where the polymer beads are to be used as an ion exchange resin, once the polymerisation reaction is substantially complete, the beads may be optionally treated to introduce sites in the polymer for ion exchange and the beads recovered. The manner in which the polymer beads are treated will depend on the type of functional monomers used to prepare the beads and the nature of the species to be separated from solution. For example, hydrolysis of poly(ethyl acrylate) beads will provide a weak acid cation ion exchange resin suitable for separating transition metal ions such as cadmium and zinc from solution. Amination or quaternization of the polymer beads may be used to provide an ion exchange resin suitable for the removal of acidic organic materials from solution. Those skilled in the art will appreciate the variety of reagents and conditions that may be used to introduce the ion exchange properties to particular polymer beads.

The beads may require cleaning before use. This may be achieved by a sequence of washing steps or by steam stripping the beads.

One method for cleaning the polymer beads includes the following steps:
(a) add reaction product to a large excess of water, stir and allow to settle;
(b) separate beads from the supernatant;
(c) add separated beads to a large excess of water, stir and allow to settle before separating beads from the supernatant;
(d) repeat step (c) several times;
(e) optionally disperse water washed beads in alcohol (ethanol);
(f) separate beads from alcohol and dry.

An alternative clean-up procedure is to steam strip the porogens and then wash the polymer beads to remove any free solid particulate material.

Advantageously, the process of the present invention provides polymer beads that will generally be easier to clean than beads prepared by other processes.

In a preferred embodiment of the invention the polymer beads are formed as a copolymer of glycidyl methacrylate and divinyl benzene. The monomers reside in the organic phase, which also includes a mixture of cyclohexanol with toluene or dodecanol as porogens. Polyvinyl alcohol is used as a stabilising agent. A free radical initiator such as “VAZO” 67 or Azoisobutyronitrile (AIBN) is added to the organic phase as a polymerisation initiator and γ-iron oxide is the magnetic material. The organophosphorus dispersing agent preferred for use in this system is sold under the trade name Crafol® AP12. Crafol® AP12 is a phosphate ester dispersing agent comprised of a hydrophobic alkyl chain and a hydrophilic end group containing ethylene oxide units and a phosphate ester group. All of the components of the organic phase are preferably pre-mixed in a separate tank and dispersed in water in the reaction tank. Once the polymerisation reaction is substantially complete, the resultant polymer beads can be subsequently reacted through the epoxy group with a compound such as an amine or its salt to provide for a complexing or ion exchange resin. Reaction with the amine compound may be promoted or accelerated by heating.

In another preferred embodiment of the invention, the polymer beads also incorporate a toughening agent. The toughening agent is selected to increase the impact resistance of the polymer. General techniques for increasing toughness of polymer materials may be readily employed in the process of the invention to afford polymer beads with increased durability. For example, rubber toughening agents may be used to improve the strength and durability of glycidyl methacrylate-based polymer beads. The use of these rubber toughening agents is believed to result in improved durability and an increased service life of the polymer beads. The rubber toughening agents include low molecular weight rubbers which may be incorporated into the dispersed phase. A particularly preferred rubber toughening agent is sold under the trade name Kraton® D1102, although other commercially available rubber toughening agents can be used.

In another aspect, the present invention provides a method of separating transition metal ions from an aqueous solution comprising contacting said solution with polymer beads of complexing resin prepared in accordance with the present invention. The polymer beads comprising complexed transition metal ions can then be separated from the solution utilising the beads' magnetic properties. For example, in the absence of shear, the beads can aggregate through magnetic attraction and settle out of the treated solution. Alternatively, they can be separated on a wet high intensity magnetic separator or magnetic drum separator or similar device.

In further aspect, the present invention provides a method of separating ions from an aqueous solution comprising contacting said solution with polymer beads of ion exchange resin prepared in accordance with the present invention. The polymer beads together with the adsorbed ions can then be separated from the solution utilising the beads' magnetic properties. For example, in the absence of shear, the beads can aggregate through magnetic attraction and settle out of the treated solution. Alternatively, they can be separated on a wet high intensity magnetic separator or magnetic drum separator or similar device. Examples of anions that may be separated from the aqueous solution include, but are not limited to, dissolved organics such as humates and fulvates, chromate, arsenate, arsenite, selenate, selenite, phosphate and perchlorate. Examples of cations that may be separated from the aqueous solution, other than the transition metals mentioned above, include, but are not limited to, calcium and magnesium.

As the magnetic iron oxide particles are dispersed throughout the polymer beads of the present invention, the magnetic particles are not easily removed from the beads and this allows the beads to be subjected to a number of handling operations, such as conveying, pumping and mixing, without substantial erosion of solid particles therefrom.

The invention further provides ion exchange or complexing resins including polymer beads prepared in accordance with the present invention.

The invention will be further described with reference to the following non-limiting Examples.

### General Experimental Procedure 1

The effectiveness of different organophosphorus compounds in dispersing magnetic iron oxide in organic media was assessed by adding 10.23 g of maghemite to 11.52 g of cyclohexanol, followed by the candidate dispersant, which was added incrementally with vigorous stirring. Cyclohexanol and Disperbyk® 163 were used as controls. Addition of cyclohexanol in amounts up to 2.6 g failed to disperse the maghemite, which remained clumped, whereas 0.8 g of Disperbyk® 163 (available from Byk Chemie) yielded a homogeneous dispersion of conveniently low viscosity. Trialkyl phosphates, represented by tributyl phosphate and trioctyl phosphate, failed to disperse the maghemite when added in amounts up to 7 g, as did another nonionizable organophosphorus compound, trioctyl phosphine oxide.

In contrast the ionizable organophosphate esters dibutyl hydrogen phosphate and bis(2-ethylhexyl) hydrogen phosphate yielded moderately viscous dispersions of maghemite in cyclohexanol when added at about 2.5 to 2.8 g. Ionizable organophosphate esters in which the organo-component is an ethoxylated alkyl chain, such as Teric(® 305 (available from Huntsman) and Crafol® AP12 (available from Cognis) yielded homogeneous dispersions of similar viscosity when added at about 0.7 g based on the active constituent.

Further details on the nature of Teric® 305, Crafol® AP 15 and Disperbyk® 163 are given below.

### General Experimental Procedure 2

The effectiveness of different dispersants in dispersing and retaining magnetic iron oxide in ion exchange polymer beads was assessed by preparing and functionalising glycidyl methacrylate-based polymer beads using the following raw materials:

1. Water: This is the continuous medium in which the organic phase is dispersed and then reacted.

2. Gohsenol® GH 17 or GH20 (available from Nippon Gohsei) This is a high molecular weight polymeric surfactant, a polyvinyl alcohol, that disperses the organic phase in the water as droplets.

3. Cyclohexanol: This is the major porogen: it is a solvent for the monomers, but a non-solvent for the polymer, and it promotes the formation of voids and internal porosity in the resin beads.

4. Toluene: this is the minor porogen.

5. A selected dispersing agent for dispersing the iron oxide particles

6. Pferrox® 2228HC γ-Fe₂O₃ (available from Pfizer): Gamma-iron oxide (maghemite). This is the magnetic oxide that makes the resin beads magnetic.

7. Kraton® D1102: (available from Shell Chemical Company) This is a low molecular weight rubber, incorporated into the organic phase to toughen the polymer beads.

8. DVB-55 (divinyl benzene): This is the monomer that crosslinks the beads.

9. GMA (glycidyl methacrylate): This monomer is polymerised to form part of the polymer matrix. The polymerised residue of the monomer provides epoxy groups within the matrix that can be subsequently reacted to produce an ion exchange resin as follows:

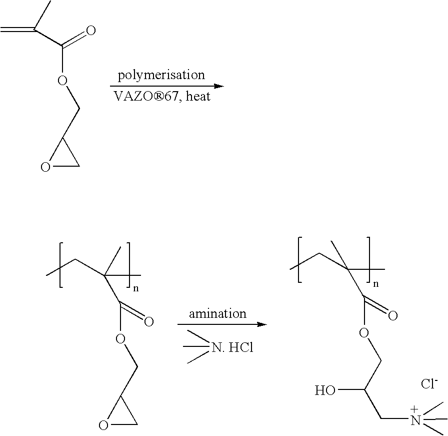

10. Trimethylamine (TMA) hydrochloride: this is the acidified amine that reacts with the epoxy group of the glycidyl methacrylate to form quaternary ammonium ion exchange sites. Alternatively, if a complexing resin is to be prepared the amination may be conducted using piperidine instead of TMA.

11. VAZO® 67 (available from Dupont): this is the polymerisation initiator, which activates when the mixture is heated above 60° C.

### Method

1. Water (168.9 g) and polyvinyl alcohol (Gohsenol® GH20, 0.21 g) were weighed out and added to a 250 mL reactor.

2. The PVA was dissolved by stirring at 400 rpm, under nitrogen at 80°-85° C., for 1.5 hours.

3. The organic phase was prepared by adding γ-iron oxide (Pferrox® 2228HC, 19.5 g) to a solution of the selected dispersant (1.73 g actives) in toluene (3.75 g), cyclohexanol (28.85 g), divinylbenzene (55% active, 7.8 g) and GMA.

4. The slurry was dispersed with a high speed disperser for 7 minutes.

5. Optionally, rubber solution (Kraton® D-1102, 7.59 g) was added and dispersing continued for a further 2 minutes.

6. A solution of VAZO 67 (0.15 g) in toluene (0.36 g) was mixed with more GMA to bring the total amount of GMA to 31.2 g. This mixture was added to the organic phase.

7. The organics were then added to the water phase while the system was stirred at 600 rpm for 30 seconds. Stirring was then reduced to 350 rpm and polymerisation carried out for 2.5 hours.

8. The nitrogen flow was turned off after polymerisation.

9. Trimethylamine hydrochloride (57% aqueous solution, 29.43 g) and water (20 mL) were added to the reactor and stirring continued for a further 3 hours to introduce strong base ion exchange functionality.

### EXAMPLE 1

### Dispersing Agent=Teric® 305

General experimental procedure 2 was performed using Teric® 305 as the dispersant. Teric® 305 (available from Huntsman) contains an ethoxylated alkyl chain and a phosphate ester end group. Substantially all of the iron oxide was found to be incorporated into the resin beads, leaving the supernatant free of iron oxide. The iron oxide was also found to be uniformly distributed throughout the beads. When 0.2 g of this resin was added to 0.5 litres of a 10 mg/L tannic acid solution (simulating a water containing natural organic colour), 24% of the tannic acid was adsorbed by the resin in 30 minutes and 65% was adsorbed in 120 minutes.

### EXAMPLE 2

### Dispersing Agent=Alkanate® 40PF

General experimental procedure 2 was performed using Alkanate® 40PF as the dispersant. Alkanate® 40PF (Huntsman) is a phosphate-containing dispersant similar in composition to Teric® 305. The iron oxide was found to be uniformly distributed in the beads and the amount of iron oxide in the supernatant was found to be very low (less than 1% of the total iron oxide).

### EXAMPLE 3

### Dispersing Agent=Alkyl Ethoxylate Phosphate Esters

General experimental procedure 2 was performed using dispersants having hydrophobic alkyl chains of different length and a hydrophilic end group consisting of an ethylene oxide block terminated by a phosphate ester group. Such dispersants are available from Cognis under the Crafol trade mark. Crafol® AP12, AP60 and AP69 all showed excellent iron oxide retention and uniform distribution when used as the dispersant in general experimental procedure 2. The supernatents contained substantially no free oxide.

### COMPARATIVE EXAMPLE 1

### Dispersing Agent=Teric® 17A10 and 17A25

General experimental procedure 2 was performed using Teric® 17A10 or 17A25 as the dispersant. Teric® 17A10 and 17A25 (Huntsman) are C₁₆₋₁₈ alcohol ethoxylates, having 10 and 25 moles of ethylene oxide per mole of alcohol respectively. They are therefore similar to the dispersants used in Examples 1-3 except that they do not contain phosphorus. Some of the resultant resin beads had iron oxide loosely attached to the surface but most beads contained no oxide.

### COMPARATIVE EXAMPLE 2

### Dispersing Agent=Dusperse® IC100

General experimental procedure 2 was performed using Dusperse(® IC100 as the dispersant. Dusperse® IC100 (Huntsman) is similar to Teric® 17A10, being an unsaturated C₁₈ alcohol ethoxylate having 10.5 moles of ethylene oxide per mole of alcohol. It contains no phosphorus. The resultant resin beads were also free of iron oxide or at best had some oxide particles loosely attached to the surface.

### EXAMPLE 4

### Dispersing Agent=Solsperse® 61000

General experimental procedure 2 was performed using Solsperse® 61000 as the dispersant. Solsperse® 61000, available from Avecia, is a polymeric dispersant having a phosphate anchor group as described in U.S. Pat. No. 6,562,897. Use of this dispersant was found to result in dense, spherical magnetic resin beads with excellent iron oxide retention. The very small amount of free iron oxide was easily removed by two decant washes.

### COMPARATIVE EXAMPLE 3

### Dispersing Agent=Solsperse® 24000SC

General experimental procedure 2 was performed using Solsperse® 24000SC as the dispersant. Solsperse® 24000SC is a polymeric dispersant comparable to Solsperse® 61000 but having a polyamine anchor block instead of the phosphorus group. Use of this dispersant was found to result in magnetic resin beads of satisfactory morphology. Iron oxide retention was just acceptable, but about 4% of the oxide used was not incorporated into beads and extensive washing was necessary.

### COMPARATIVE EXAMPLE 4

### Dispersing Agent=Disperbyk® 163

General experimental procedure 2 was performed using Disperbyk® 163 as the dispersant. Disperbyk® 163, available from Byk Chemie, is similar in structure to Solsperse® 24000SC. About 4% of the iron oxide was found not to be incorporated in the magnetic resin beads.

### EXAMPLE 5

### Dispersing Agent=Disponil® AEP5300 and Rhodafac® PE510

General experimental procedure 2 was performed using Disponil® AEP5300 or Rhodafac® PE510 as the dispersant. Disponil® AEP5300 (Henkel) and Rhodafac® PE510 (Rhodia) are alkyl phenol ethoxylates containing acid phosphate ester groups.

When used in general experimental procedure 2, but performed on ten times the scale, these ethoxylates proved excellent dispersants for iron oxide, with very little oxide not incorporated into the resin beads.

Dispersants containing phosphate groups were found to promote virtually complete (more than 99%) incorporation of the oxide in the resin beads. Alky ethoxylate phosphate dispersants also increased the density of the beads (by up to 60%), resulting in improved settling rates and improved bead morphology, yielding beads of good sphericity and attrition resistance. For example, magnetic beads made with Teric® 305, as in Example 1, had a settling rate in water of 7.3 metres per hour whereas magnetic beads made with Disperbyk® 163, as in Comparative Example 4, had a settling rate of 6.1 metres per hour. In a standard attrition test the mean diameter of washed beads from Example 1 decreased by 1.6% and the content of fine particles identified with resin fragments or free iron oxide increased from 0.06% only to 0.09% by volume, whereas in an identical test on washed beads from Comparative Example 4 the mean diameter decreased by 5.8% and the volume fraction of fines increased form 0.02% to 4.1%, indicating loss of iron oxide weakly attached to the bead surface.

### EXAMPLE 6

### Dispersing Agent=Bis(2-Ethylhexyl) Hydrogen Phosphate

General experimental procedure 2 was performed using bis(2-ethylhexyl) hydrogen phosphate as the dispersant. The dispersion was more viscous than those obtained with ethoxylated organophosphorus dispersants and the resulting magnetic resin particles varied in size and shape, but substantially all of the iron oxide was found to be incorporated into the resin particles, leaving the supernatant largely free of iron oxide. The iron oxide was also found to be uniformly distributed throughout the particles.

### General Experimental Procedure 3

Styrenic-based polymer beads were prepared as outlined below using the following raw materials:

1 Water.

2 Gohsenol® GH17.

3 Cyclohexanol.

4 Toluene.

5 A selected dispersing agent for dispersing the iron oxide particles.

6 Pferrox.®. 2228HC. γ-Fe₂O₃.

7 DVB-55 (divinyl benzene).

8 VAZO®-67.

9 4-methylstyrene: This is the major monomer polymerised to form the beads:

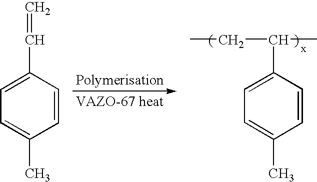

10 The resultant beads may be subsequently chlorinated (eg. with hypochlorite (OCI⁻) in the presence of a phase transfer catalyst (PTC)) to place reactive chlorine groups onto the beads, which are then aminated (eg with trimethylamine) to create the ion exchange sites (see below for further details):

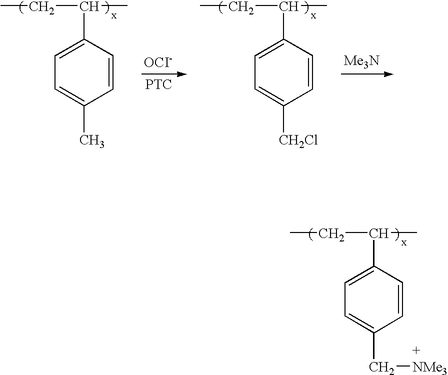

### Method

Water (168.9 g) was charged to a 250 mL reactor and the stirrer and nitrogen purge started. Next Gohsenol® GH-17 (3.38 g) was added, and the water phase heated to 82° C. to dissolve the surfactant. While the water was heating the organic phase was prepared separately. The toluene (3.00 g), selected dispersant and DVB (6.24 g) were added to a beaker containing the Pferrox® (15.6 g). Methylstyrene (18.20 g) and cyclohexanol (23.09 g) were then added. The slurry was dispersed using a high shear disperser for 5 minutes. Lauroyl peroxide (0.60 g) was dissolved in the minimum toluene (˜1 g) and then added to organic phase with mixing. Once the organic phase was thoroughly mixed, it was added to the heated water phase. The resulting dispersion was held at 65° C. (+/−2° C.) for twenty hours, during which time polymerisation occurred and the solid resin beads formed.

### EXAMPLE 7

### Dispersing Agent=Crafol® AP12

General experimental procedure 3 was performed using Crafol® AP12 (1.73 g actives) as the dispersant. Crafol® AP12 is available from Cognis. Substantially no iron oxide is found in the aqueous phase, with all of it being retained within the polymer bead. Upon cracking open the beads, the iron oxide was found to be evenly distributed within the polymer beads.

### COMPARATIVE EXAMPLE 5

### Dispersing Agent=Disperbyk® 163

General experimental procedure 3 was performed using Disperbyk® 163 (1.73 g actives). At the end of the polymerisation stage, 4% of the total iron oxide charged to the reaction was excluded from the beads, leaving the aqueous phase a muddy orange colour. Upon cracking open the beads, the iron oxide was found to be evenly distributed within the polymer beads.

Beads prepared in Example 7 and Comparative Example 5 were subsequently functionalised according to the following scheme:

1. The magnetic polymethylstyrene beads are washed and dried

2. Dichloromethane is used to swell the beads before and during functionalisation

3. Sodium hypochlorite (11% w/w solution) is used to chlorinate the methylstyrene groups

4. Hydrochloric acid (concentrated) is used to adjust the pH of the sodium hypochlorite solution down to 8.5

5. Benzyltriethylammonium chloride (50% solution in water) is used as a phase transfer catalyst and assists with the chlorination reaction.

6. Trimethylamine (33% in ethanol) is used to impart strong base functionality to the chlorinated beads.

### EXAMPLE 8

### Functionalisation of Polymer Beads Prepared in Accordance with Example 7.

5.0 g of clean and dry magnetic polymethylstyrene beads prepared in Example 7 were swelled in dichloromethane (40 mL) for one hour in a stirred flask. 11% w/w sodium hypochlorite solution (200 mL) was adjusted to pH 8.5 using concentrated HCl, and then added to the flask. Benzyltriethylammonium chloride (1.0 g) was then added. The mixture was stirred for 16 hours at room temperature. The beads were washed with water, ethanol, dichloromethane, ethanol and water, then resuspended in water (70 mL). The reaction mixture was heated to 75° C. Trimethylamine (33% in ethanol) (9.1 g, 51 mmol) was added, and the reaction carried out for 6 hours.

An ash analysis on the resin indicated that the iron oxide content had not been reduced by the reaction, and the magnetic properties were maintained. A strong base capacity of 1.4 milliequivalents per gram resulted.

### EXAMPLE 9

Styrenic polymer beads were prepared in the manner of Example 7, except that methylstyrene was replaced by styrene. The resultant beads had iron oxide evenly distributed through them, and no iron oxide was found in the aqueous phase.

### General Experimental Procedure 4

The effectiveness of different dispersants in dispersing and retaining magnetic iron oxide in ion exchange polymer beads was further assessed by preparing and functionalising methyl acrylate-based polymer beads using the following raw materials:

1. Water.

2. Gohsenol® GH17.

3. Sodium chloride: this is used to ‘salt out’ the monomers and minimise formation of waste polymer.

4. Cyclohexanol.

5. Toluene.

6. A selected dispersing agent for dispersing the iron oxide particles.

7. Pferrox® 2228HC.

8. DVB-55 (divinyl benzene).

9. Methyl acrylate: this is the monomer that is first polymerised to incorporate it into the beads, then it is derivatised to place functional groups into the beads.

10. Lauroyl peroxide: this is the catalyst that initiates polymerisation when the mixture is heated above 50 degree C.

### Method

Water (170 g) was charged to a 250 mL reactor and the stirrer and nitrogen purge started. Next Gohsenhol® GH-17 (0.21 g) and sodium chloride (5.5 g) were added, and the water phase heated to 65 degree C. (+/−2 degree.C.) to dissolve the surfactant. While the water was heating the organic phase was prepared separately. The toluene (3.00 g), the selected dispersant (1.73 g actives) and DVB (6.24 g) were added to a beaker containing the Pferrox® (15.6 g). Methyl acrylate (18.20 g) and cyclohexanol (23.09 g) were then added. The slurry was dispersed using a high shear disperser for 5 minutes. Lauroyl peroxide (0.60 g) was dissolved in the minimum toluene (˜1 g) and then added to organic phase with mixing. Once the organic phase was thoroughly mixed, it was added to the heated water phase. The resulting dispersion was held at 65 degree. C. (+/−2 degree.C.) for twenty hours, during which time polymerisation occurs and the solid resin beads form.

### EXAMPLE 10

### Dispersant Agent=Crafol® AP-12

General experimental procedure 4 was performed using Crafol® AP-12 as the dispersant. Substantially no iron oxide was found in the aqueous phase, with all of it being retained within the polymer bead. Upon cracking open the beads, the iron oxide is found to be evenly distributed within the polymer beads. The poly(methyl acrylate)/DVB/iron oxide resin beads were treated with NaOH (1 M) for 24 hours under stirring. The beads were then filtered off and the resin converted to H+ form, then dried to constant weight. The weak acid capacity was determined to be 1.4 meq/g by a method taken from Harland, C. E., Ion Exchange: Theory and Practice, Royal Society of Chemistry Paperbacks, 1994.

### COMPARATIVE EXAMPLE 6

### Dispersant Agent=Disperbyk® 163

General experimental procedure 3 was performed using Disperbyk® 163 (1.73 g actives) as the dispersant. At the end of the polymerisation stage, approximately 6% of the total iron oxide charged to the reaction had been excluded from the beads, leaving the aqueous phase a muddy orange colour. There were also some large lumps of iron oxide at the bottom of the reactor. Upon cracking open the beads, the iron oxide was found to be evenly distributed within the polymer for the majority of the beads, however some of the beads had a graduation in iron oxide incorporation density from one side to the other.

### Magnetite-Containing Resin

### EXAMPLE 11

A polyglycidyl methacrylate resin was prepared with Crafol® AP-12 as the dispersant substantially as described in Example 3, except that gamma iron oxide was replaced by magnetite. The supernate contained a negligible amount of free iron oxide.

### Weak Base Complexing Resin

### EXAMPLE 12

A polyglycidyl methacrylate resin was prepared with Crafol® AP-12 as the dispersant substantially as described in Example 3, except that the magnetic beads were functionalised with piperidine in place of trimethylamine to produce a weak base resin capable of complexing transition metal cations.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia or elsewhere.

Those skilled in the art will appreciate that the invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

1. A process for preparing polymer beads incorporating magnetic iron oxide particles, which process comprises producing a dispersion having a continuous aqueous phase and a dispersed organic phase, the organic phase comprising one or more polymerisable monomers, magnetic iron oxide particles and an organophosphorus dispersing agent for dispersing the magnetic iron oxide particles in the organic phase, and polymerising the one or more polymerisable monomers to form the polymer beads incorporating the magnetic iron oxide particles.

2. The process according to claim 1, wherein the organophosphorus dispersing agent comprises one or more phosphorus groups independently selected from phosphonic acid, phosphonate, and ionisable phosphate ester or salt thereof.

3. The process according to claim 1 or 2, wherein the organophosphorus dispersing agent comprises one or two organo-substituents independently selected from C₈ to C₁₈ linear or branched alkyl groups and their ethoxylated derivatives.

4. The process according to any one of claims 1 to 3, wherein said one or more polymerisable monomers are selected from:
a) crosslinking monomers which are able to provide crosslinked points; and
b) functional monomers which are able to provide functional groups.

5. The process according to claim 4, wherein the functional monomers provide functional groups which (a) directly give the polymer beads an ion-exchange or complexing capability, or (b) may be reacted with one or more compounds to provide functional groups that afford ion-exchange or complexing capability to the polymer beads.

6. The process according to claim 5, wherein the functional monomers contain functional groups which directly give ion exchange or complexing capability to the polymer beads.

7. The process according to claim 6, wherein the functional monomers contain an acid or amine group.

8. The process according to claim 5, wherein the functional monomers contain functional groups which, upon reaction with one or more compounds, can be converted into functional groups which afford ion exchange or complexing capability to the polymer beads.

9. The process according to claim 8, wherein the functional monomers contain an amide or an ester group.

10. The process according to claim 9, wherein the amide or ester groups present in the polymer beads are converted into amine groups or salts thereof.

11. The process according to claim 9, wherein the ester groups in the polymer beads are converted into acid groups, or salts thereof.

12. The process according to claim 5, wherein the functional monomers contain functional groups which can be reacted with one or more compounds which contain functional groups that afford ion exchange or complexing capability to the polymer beads.

13. The process according to claim 12, wherein the functional monomers contain a halogen, epoxy, ester or amide group.

14. The process according to claim 12, wherein the one or more compounds react with the functional groups of the functional monomers to introduce amine groups or salts thereof to the polymer beads.

15. The process according to any one of claims 1 to 14, wherein the organic phase comprises two or more polymerisable monomers.

16. The process according to any one of claims 1 to 15, wherein the one or more polymerisable monomers further comprises one or more backbone monomers.

17. The process according to any one of claims 1 to 16, wherein the organic phase further comprises a porogen.

18. The process according to any one of claims 1 to 17, wherein the magnetic iron oxide is selected from maghemite and magnetite.

19. A complexing or ion exchange resin prepared by the process of any one of claims 1 to 18.

20. A method of separating transition metal ions from an aqueous solution, the method comprising contacting the solution with the complexing resin according to claim 19.

21. A method of separating ions from an aqueous solution, the method comprising contacting the solution with the ion exchange resin according to claim 19.

22. Polymer beads comprising a polymeric matrix having magnetic iron oxide particles and an organophosphorus dispersing agent dispersed substantially uniformly therein.
